(19) United States
(12) Patent Application Publication
(10) Pub. No.: US 2019/0370045 A1
(43) Pub. Date: Dec. 5, 2019

(54) DIRECT PATH TO STORAGE

(71) Applicant: Microsoft Technology Licensing, LLC, Redmond, WA (US)

(72) Inventors: Karan MEHRA, Sammamish, WA (US); Sachin Chiman PATEL, Redmond, WA (US); Taylor Alan HOPE, Redmond, WA (US); Vinod R. SHANKAR, Redmond, WA (US)

(21) Appl. No.: 15/993,480

(22) Filed: May 30, 2018

(51) Int. Cl. G06F 9/455; G06F 3/06

(52) U.S. Cl. CPC G06F 9/45558; G06F 3/0611; G06F 2009/45583; G06F 3/068; G06F 3/0664

(57) ABSTRACT

Techniques are disclosed for implementing a resilient object layer and namespace that are operable to provide a communication path to storage devices underlying virtualized storage services of a computing environment. The resilient object layer and namespace comprise a compression of at least two layers of a storage stack. A request is received for an operation that includes access to the virtualized storage services. Storage destination locations of the virtualized storage services associated with the request are mapped, using the resilient object layer and namespace, to a plurality of physical locations of the corresponding underlying storage devices.

### BACKGROUND

Storage technologies have continuously improved. For example, storage-class memory (SCM) is a type of persistent memory that combines characteristics of a solid-state memory with those of conventional hard-disk magnetic storage.

Virtualization is one example of a technology that may consider incorporation of such storage technologies. Virtualization enables the creation of a fully configured computer based entirely on a software implementation. For example, when a guest computer system is emulated on a host computer system, the guest computer system is said to be a “virtual machine” as the guest computer system exists in the host computer system as a software representation of the operation of one specific hardware architecture. Within a virtual machine, an operating system may be installed just like it would be on physical hardware. Virtual machines may also use virtualized storage resources, which may be abstractions of actual storage devices which may include various storage technologies.

Other applications that utilize storage such as file share, database, web server, and streaming applications may also benefit from such storage technologies. It is with respect to these considerations and others that the disclosure made herein is presented.

### SUMMARY

The disclosed embodiments describe technologies that allow various applications such as virtualized resource services to leverage the improvements to read and write access times in storage devices. By providing more direct access to underlying storage devices, applications and service providers may provide services in a way that allow for improved overall performance based on the improvements available on many storage technologies. By providing such direct access and the resulting performance improvements, applications and service providers may achieve higher levels of operational performance while improving operating efficiencies, while at the same time improving the user's experience. While the disclosed techniques may be implemented in a variety of contexts and applications, for the purpose of illustration the present disclosure will illustrate the techniques in the context of virtualization environments. However, the disclosed techniques may be applicable to any application that accesses storage, such as file share, database, web server, streaming, and other applications.

While virtualization technologies provide many benefits to computing users, current implementations of virtual machines often include many layers of services that may mask the ability to leverage the improvements to access times for storage devices. When the underlying storage technology provided slower access speeds such in the case of rotational drives, the performance of virtual machines was not significantly impacted as the traversal of multiple stack layers could be completed without disk storage access being a bottleneck.

New technologies may include HDD, SSD, and SCM which may allow for close to RAM speeds. Additionally, direct memory access methods such as RDMA may also provide low latency network and memory access. The use of hyperconverged infrastructure (HCl) where storage, computing, and networking may be virtualized in an integrated virtualization environment provide further motivation for leveraging the advantages of these new storage technologies. However, with the advent of faster bulk storage devices such as SSD, the time that it takes for tasks and processes to traverse the stacks may exceed the faster access times for the newer storage technologies. For example, a write may take 8 microseconds. However, 60 microseconds may be added for latencies, and another 120 to 150 microseconds for the various stacks traversed by the virtual machine. Typically each function call is processed through a number of layers in the stack. Thus with the current virtual machine architectures, it is not possible to realize, by the applications running on the virtual machines, the fast access times that are now available.

In an embodiment, the execution layers of stacked services such as a storage stack may be modified to reduce the numbers of layers in the execution stack. In some embodiments, some stack layers may be removed. In further embodiments, selected functionality of existing layers may be collapsed or compressed to a lesser number of layers, and even reduced to one layer. Additionally, a more direct path to the underlying storage devices may be implemented, which may be referred to herein as a resilient object path. The resilient object path may provide a compressed and more direct path for access to and from storage in a way that is more suited for and optimized for applications such as a virtualized environment. By providing a compressed and more direct path for access to and from storage, latencies for performing operations may be reduced. Furthermore, reducing or compressing the stack layers can free up processing and memory resources, allowing for more efficient use of resources.

In some embodiments, the execution path for a virtual machine task or process may be implemented to provide the most direct path to the underlying stored data. Some tasks that are typically executed at one of the stack layers such as encryption may be offloaded to client level applications so as to reduce the latencies in a reduced and compressed stack. Thus in some embodiments, functions that are not determined to be essential for the virtual machine workload and can be performed elsewhere may be eliminated from the stack. Functions to be included in the reduced and compressed stack may be selected which are necessary for effectuating the communications through the compressed stack.

In an embodiment, when a virtual machine is started, a file path may be provided that enables the virtual machine to directly identify and connect to the underlying storage. In some embodiments, the path may be referred to as a resilient object (RO) path. The RO path may be implemented to allow for direct or near-direct access to storage resources. In an embodiment, the RO path may include a namespace capable of identifying a sufficient number of objects such as virtual storage disks without creating a full filing system since specific access to disk objects and other items are not needed. In some embodiments, the RO namespace may be a flat namespace that is scalable to accommodate additional RO paths. Typically, the namespace is at the top of the stack and the RO path is at the bottom of the stack.

In some embodiments, the RO namespace may be operable to perform reads and writes, and address objects in its namespace. In one example, a virtual machine may use the RO namespace to access a database such as “Cluster A SQL.” The virtual machine does not need to know the specific identifiers of the storage hardware, but by using the RO namespace may be able to directly address areas of the storage hardware. In one embodiment, the virtual machine may address storage areas by using the RO namespace with the IP address and a disk ID.

The RO namespace may be configured to receive a name of an entity in the namespace that the virtual machine can call, and translate the called name to a physical namespace. In one example, an entity may be addressed as an IP address and a disk ID. For example, storage devices may be called as SCM 1 at node 1 and SCM 2 at node 2.

In an embodiment, the RO functionality may reside in the OS. The RO namespace data may be communicated via the virtual machine bus. The hypervisor may be configured to manage the RO path, while from the individual virtual machine perspective, no changes are specifically required. By maintaining a mapping between the virtual machine's call to storage and the underlying storage device, applications need not make any changes to realize the benefits of fast storage access. Thus the operation of virtualized computing services may be improved, providing faster access to storage on par with improvements to storage technology, while maintaining the benefits of virtualized storage in an HCl environment and also providing resiliency if desired.

In one embodiment, the virtual machine bus may provide plugins for providing an RO path. For example, if the host receives a read/write request, the host may find the RO path to send the request to, and open a handle to this path. In one example implementation, after instantiation or loading of a virtual machine and applications running on the virtual machine, when an application requests a write operation, the application may be exposed to a disk which may be redirected via a resilient object path. A backend may be instantiated that interfaces to the disk and provides a namespace, allowing the disk to appear as a traditional disk but without the typical layers.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating a computing environment for providing and allocating virtualized resources in accordance with the present disclosure;

FIG. 2 is a diagram illustrating an example virtualized computing environment in accordance with the present disclosure;

FIG. 3 is a diagram illustrating an example of a virtual machine accessing storage;

FIG. 4 is a diagram illustrating compression of a stack in accordance with the present disclosure;

FIG. 5A is a diagram illustrating use of a compressed stack in accordance with the present disclosure;

FIG. 5B is a diagram illustrating use of a compressed stack in accordance with the present disclosure;

FIG. 6 is a diagram illustrating use of a compressed stack in accordance with the present disclosure;

FIG. 7 is a flowchart depicting an example procedure for implementing virtual machines in accordance with the present disclosure;

FIG. 8 is a flowchart depicting an example procedure for implementing virtual machines in accordance with the present disclosure;

FIG. 9 is a flowchart depicting an example procedure for implementing virtual machines in accordance with the present disclosure;

FIG. 10 is an example computing device in accordance with the present disclosure.

### DETAILED DESCRIPTION

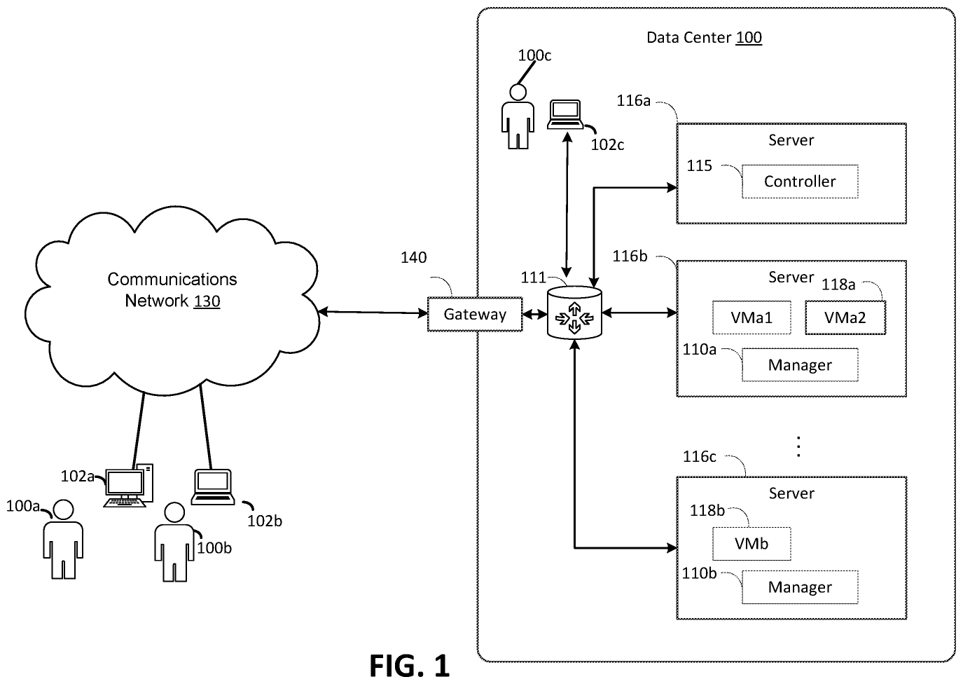

Described herein are technologies that allow for improvements to the performance of computing, storage, and network services provided by applications and service providers that utilize storage devices. FIG. 1 illustrates an example computing environment in which the embodiments described herein may be implemented. FIG. 1 illustrates a data center 100 that configured to provide computing resources to users 100a, 100b, or 100c (which may be referred herein singularly as “a user 100” or in the plural as “the users 100”) via user computers 102a,102b, and 102c (which may be referred herein singularly as “a computer 102” or in the plural as “the computers 102”) via a communications network 130. The computing resources provided by the data center 100 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like. Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

Data center 100 may include servers 116a, 116b, and 116c (which may be referred to herein singularly as “a server 116” or in the plural as “the servers 116”) that provide computing resources available as virtual machines 118a and 118b (which may be referred to herein singularly as “a virtual machine 118” or in the plural as “the virtual machines 118”). The virtual machines 118 may be configured to execute applications such as Web servers, application servers, media servers, database servers, and the like. Other resources that may be provided include data storage resources (not shown on FIG. 1) and may include file storage devices, block storage devices, and the like. Servers 116 may also execute functions that manage and control allocation of resources in the data center, such as a controller 115. Controller 115 may be a fabric controller or another type of program configured to manage the allocation of virtual machines on servers 116.

Referring to FIG. 1, communications network 130 may, for example, be a publicly accessible network of linked networks and may be operated by various entities, such as the Internet. In other embodiments, communications network 130 may be a private network, such as a corporate network that is wholly or partially inaccessible to the public.

Communications network 130 may provide access to computers 102. Computers 102 may be computers utilized by users 100. Computer 102a,102b or 102c may be a server, a desktop or laptop personal computer, a tablet computer, a smartphone, a set-top box, or any other computing device capable of accessing data center 100. User computer 102a or 102b may connect directly to the Internet (e.g., via a cable modem). User computer 102c may be internal to the data center 100 and may connect directly to the resources in the data center 100 via internal networks. Although only three user computers 102a,102b, and 102c are depicted, it should be appreciated that there may be multiple user computers.

Computers 102 may also be utilized to configure aspects of the computing resources provided by data center 100. For example, data center 100 may provide a Web interface through which aspects of its operation may be configured through the use of a Web browser application program executing on user computer 102. Alternatively, a stand-alone application program executing on user computer 102 may be used to access an application programming interface (API) exposed by data center 100 for performing the configuration operations.

Servers 116 may be configured to provide the computing resources described above. One or more of the servers 116 may be configured to execute a manager 120a or 120b (which may be referred herein singularly as “a manager 120” or in the plural as “the managers 120”) configured to execute the virtual machines. The managers 120 may be a virtual machine monitor (VMM), fabric controller, or another type of program configured to enable the execution of virtual machines 118 on servers 116, for example.

It should be appreciated that although the embodiments disclosed above are discussed in the context of virtual machines, other types of implementations can be utilized with the concepts and technologies disclosed herein. For example, the embodiments disclosed herein might also be utilized with computing systems that do not utilize virtual machines.

In the example data center 100 shown in FIG. 1, a router 111 may be utilized to interconnect the servers 116a and 116b. Router 111 may also be connected to gateway 140, which is connected to communications network 130. Router 111 may manage communications within networks in data center 100, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 1 has been greatly simplified and that many more networks and networking devices may be utilized to interconnect the various computing systems disclosed herein. These network topologies and devices should be apparent to those skilled in the art.

It should also be appreciated that data center 100 described in FIG. 1 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

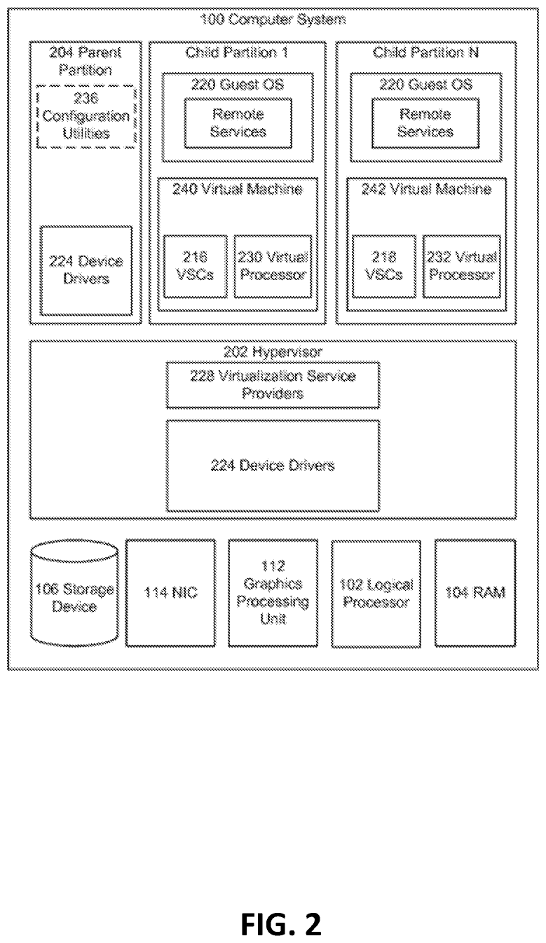

Referring now to FIG. 2, depicted is a high-level block diagram of a computer system configured to effectuate virtual machines. As shown in the figures, computer system 100 can include elements described in FIG. 1 and components operable to effectuate virtual machines. One such component is a hypervisor 202 that may also be referred to in the art as a virtual machine monitor. The hypervisor 202 in the depicted embodiment can be configured to control and arbitrate access to the hardware of computer system 100. Broadly stated, the hypervisor 202 can generate execution environments called partitions such as child partition 1 through child partition N (where N is an integer greater than or equal to 1). In embodiments a child partition can be considered the basic unit of isolation supported by the hypervisor 202, that is, each child partition can be mapped to a set of hardware resources, e.g., memory, devices, logical processor cycles, etc., that is under control of the hypervisor 202 and/or the parent partition and hypervisor 202 can isolate one partition from accessing another partition's resources. In embodiments the hypervisor 202 can be a stand-alone software product, a part of an operating system, embedded within firmware of the motherboard, specialized integrated circuits, or a combination thereof.

In the above example, computer system 100 includes a parent partition 204 that can also be thought of as domain 0 in the open source community. Parent partition 204 can be configured to provide resources to guest operating systems executing in child partitions 1-N by using virtualization service. Each child partition can include one or more virtual processors such as virtual processors 230 through 232 that guest operating systems 220 through 222 can manage and schedule threads to execute thereon. Generally, the virtual processors 230 through 232 are executable instructions and associated state information that provide a representation of a physical processor with a specific architecture. For example, one virtual machine may have a virtual processor having characteristics of an Intel x86 processor, whereas another virtual processor may have the characteristics of a PowerPC processor. The virtual processors in this example can be mapped to logical processors of the computer system such that the instructions that effectuate the virtual processors will be backed by logical processors. Thus, in these example embodiments, multiple virtual processors can be simultaneously executing while, for example, another logical processor is executing hypervisor instructions. Generally speaking, and as illustrated by the figures, the combination of virtual processors and memory in a partition can be considered a virtual machine such as virtual machine 240 or 242.

Generally, guest operating systems 220 through 222 can include any operating system such as, for example, operating systems from Microsoft®, Apple®, the open source community, etc. The guest operating systems can include user/kernel modes of operation and can have kernels that can include schedulers, memory managers, etc. A kernel mode can include an execution mode in a logical processor that grants access to at least privileged processor instructions. Each guest operating system 220 through 222 can have associated file systems that can have applications stored thereon such as terminal servers, e-commerce servers, email servers, etc., and the guest operating systems themselves. The guest operating systems 220-222 can schedule threads to execute on the virtual processors 230-232 and instances of such applications can be effectuated.

As used herein, “storage stack” refers to an entity that may include a layering of various drivers, filters, encryption logic, antivirus logic, etc. that may be used to handle transfers/transformation of data/information from main memory to other storage. For example, for I/O requests (e.g., “read/write” requests), a block of data may be “packaged” (e.g., using a construct such as an IRP (I/O Request Packet)) and passed down the stack; thus, entities in the stack handle the transfer of that data from main memory to storage. Generally, such “I/O” operations (e.g., “read/write” operations) involve more processing time (and hence, more delay time) than traditional “load/store” operations that may occur directly between a CPU and main memory (e.g., with no “storage stack” involvement in such operations).

The term “file system” is used by way of example and the discussion of example techniques herein may also be applied to other types of file systems. In this context, a “file system” may include one or more hardware and/or software components that organize data that is persisted. For example, persisted data may be organized in units that may be referred to as “files”—and thus, a “file system” may be used to organize and otherwise manage and/or control such persisted data. For example, a “file” may be associated with a corresponding file name, file length, and file attributes. A file handle may include an indicator (e.g., a number) used by the file system to uniquely reference a particular active file.

Described further are technologies that allow for applications and service providers such as virtualized resource service providers to provide resources and services that enable lower latencies when accessing storage with increased read/write performance. For example, virtualized services may leverage the latest improvements in read and write access times for various storage devices. By providing more direct access to underlying storage devices, virtualization service providers may provide services in a way that allow for improved overall performance of virtual machines based on the improvements available in many storage technologies. By providing such direct access and realizing the resulting performance improvements, service providers may provide higher levels of adherence to operational objectives while improving operating efficiencies, while the users' experiences may be improved.

Virtualization service providers typically want low latency access to underlying NVM stored on persistent memory devices such as flash storage and hard disk drives (HDDs). Flash storage may also be used to store data to support virtual machines. Devices such as flash devices may have higher throughput and lower latency as compared to HDDs.

While virtualization technologies provide many benefits to users, current implementations of virtual machines often include many layers (stacks) of services that may mask the ability to leverage the improvements to access times for storage technologies. When the underlying storage technologies were only able to achieve slower access speeds such as in the case of rotational drives, the performance of virtual machines were not significantly impacted by the slower access speeds as the traversal of multiple stack layers could be completed without the slower access speeds being a bottleneck. Existing storage software stacks in a host operating system such as Windows or Linux in many cases were originally optimized for HDD. However, HDDs typically have several milliseconds of latency for input/output operations. Because of the high latency of HDDs, the focus on code efficiency of the storage software stacks was not the highest priority. Therefore storage software stacks were not necessarily optimized for latency. Additionally, the numbers of levels in the stacks in some cases were dictated by the adopted technologies rather than being designed and optimized for the virtual machine environment. With the cost efficiency improvements of flash memory and the use of flash storage and non-volatile memory as the primary backing storage for infrastructure as a service (IaaS) storage or the caching of IaaS storage, shifting focus to improve the performance of the input/output stack may provide an important advantage for hosting virtual machines.

However, with the advent of faster bulk storage devices such as SSD, the time that it takes for tasks and processes to traverse the stacks may exceed the faster access times available for the newer storage technologies. Such new technologies may include HDD, SSD, and SCM, which may allow for close to RAM speeds. Additionally, direct memory access methods such as RDMA may also provide low latency network and memory access. For example, a write may take 8 microseconds. However, 60 or more microseconds may be added for latencies, and another 120 to 150 microseconds for the various stacks traversed by the virtual machine. Typically each function call is processed through a number of layers in the stack.

Various embodiments are described herein for reducing storage stack layers and other ways of improving latencies when executing the storage stack layers. Additionally, storage interfaces are disclosed to improve input/output performance when accessing storage in a virtual machine environment.

In some embodiments, stack layers may be combined and/or compressed to provide the fastest path through the storage stack of the host OS and ultimately to the underlying storage devices. By combining and/or compressing the layers of the storage stack, the efficiency of virtual machines may be improved by providing an optimized software stack for input/output operations, and thus allowing virtual machines to benefit from the faster access speeds of available storage devices. In one embodiment, a new layer that may be referred to as a resilient object layer may be implemented.

In an embodiment, the execution layers of a virtual machine may be modified to reduce the numbers of layers in the execution stack. In some embodiments, some stack layers may be removed. In further embodiments, selected functionality of existing layers may be collapsed or compressed to a lesser number of layers. Additionally, a more direct path to the underlying storage devices may be implemented, which may be referred to herein as a resilient object path. The disclosed path may provide a compressed and more direct path for access to and from storage in a way that is more suited for and optimized for a virtualized environment.

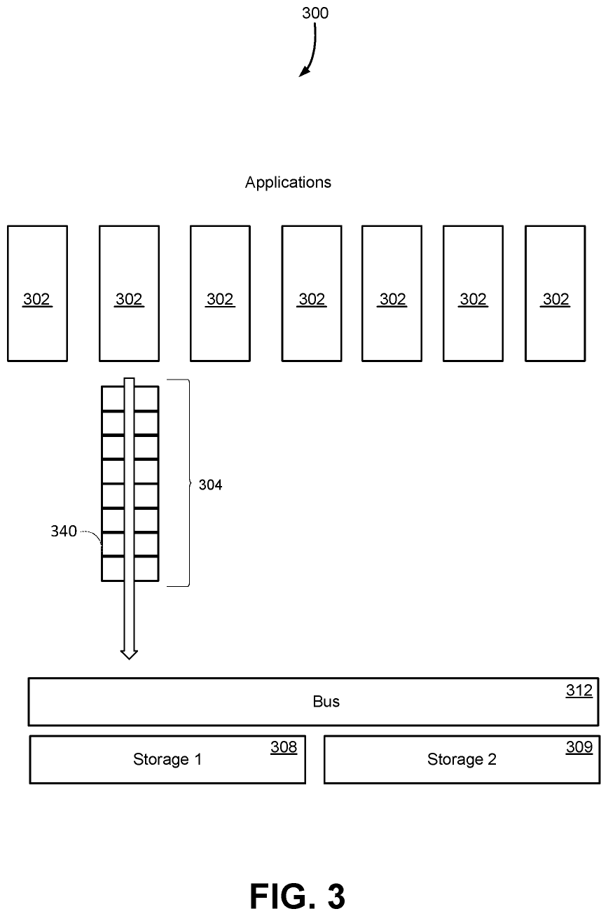

Referring to FIG. 3, illustrated is a computing environment 300 that may be viewed as a collection of shared computing resources and shared infrastructure. The computing environment may include a number of applications 302 that are running in the computing environment 300. For example, the computing environment 300 may be a virtualized computing environment may include virtual machine containers. The virtual machine containers may be hosted on physical hosts that may vary in hardware and/or software configurations. Each container may be capable of hosting a virtual machine. Computing environment 300 may also include one or more routers (not shown on FIG. 3) which may service multiple physical hosts to route network traffic. A controller or provisioning server (not shown in FIG. 3) may include a memory and processor configured with instructions to manage workflows for provisioning and de-provisioning computing resources as well as detecting accessing storage resources. As shown in FIG. 3, an application 302 may access a bus 312 to read or write data to storage type 1 308 or storage type 2 309. In order to do so, services provided by stack 304 comprising a number of layers 304 are traversed such as file system, storage, and other stack layers. As discussed, the application of the described techniques is illustrated in the context of virtualized services but are not limited to virtualized services. Any application that accesses or otherwise utilizes storage devices and services may implement the described techniques.

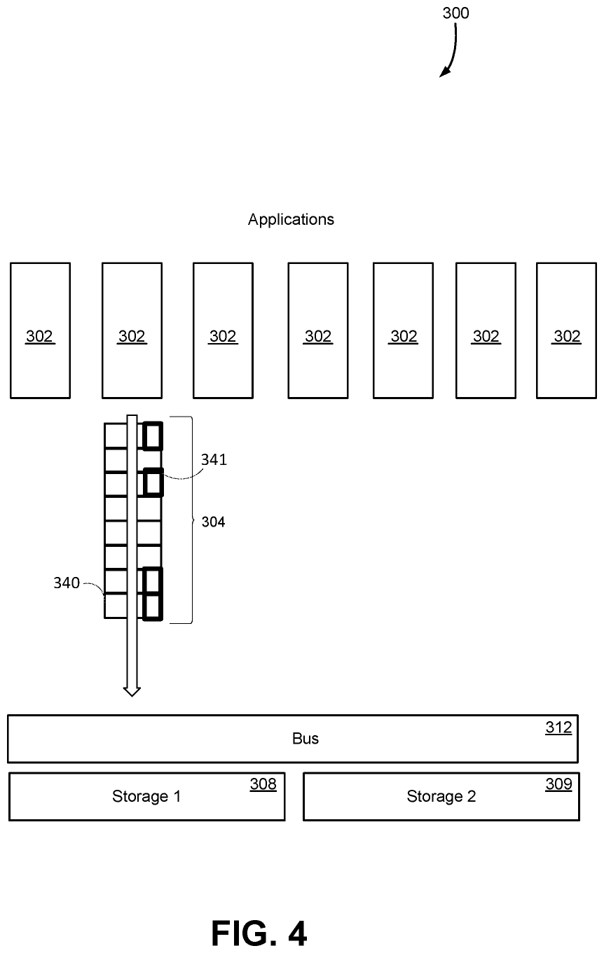

Referring to FIG. 4, the service provider may implement a resilient object layer that includes selected capabilities 341 of layers 340 in stack 304. In some embodiments, the execution path for a virtual machine task or process or other task or process may be implemented to provide the most direct path to the underlying stored data. Some tasks that are typically executed at one of the stack layers such as encryption may be offloaded to client level applications so as to reduce the latencies in a reduced and compressed stack. Thus in some embodiments, functions that are not determined to be essential for the application workload and can be performed elsewhere may be eliminated from the stack. Functions 341 to be included in the reduced and compressed stack may be selected which are necessary for effectuating the communications through the compressed stack.

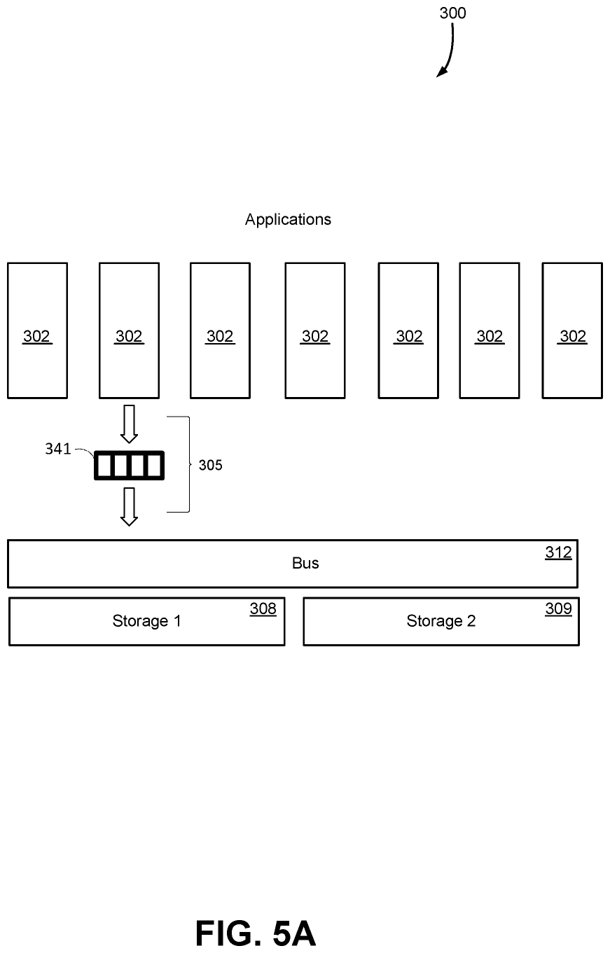

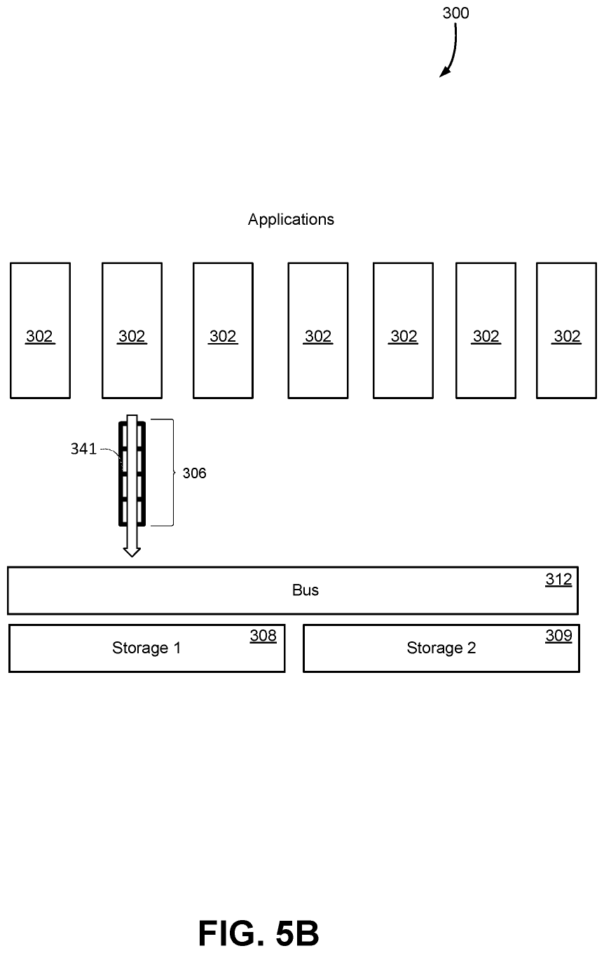

Referring to FIG. 5A, illustrated is a layer 305 that comprises the selected functions 341 of stack 304. Layer 305 may be referred to as a resilient object layer, and may also include a namespace. In an example, when a virtual machine is started, a file path may be provided by resilient object layer 305 that enables the virtual machine to directly identify and connect to the underlying storage. In some embodiments, the path may be referred to as a resilient object (RO) path. The RO path may be implemented to allow for direct or near-direct access to storage resources. The RO path may expose storage locations that are mapped to multiple storage locations in order to implement a redundancy scheme, where physical storage components are combined into one or more logical units to provide data redundancy and performance improvement. Different levels of resiliency can be achieved, for example, by different mirroring schemes or parity schemes.

In an embodiment, the RO path may include a namespace capable of identifying a sufficient number of objects such as virtual storage disks without creating a full filing system since specific access to disk objects and other items as not needed. In some embodiments, the RO namespace may be a flat namespace that is scalable to accommodate additional RO paths.

Referring to FIG. 5b, illustrated is a depiction of a compressed stack 306 that comprises the selected functions 341 of stack 304. Layer 306 may be referred to as a resilient object layer, and may also include a namespace.

In some embodiments, the RO namespace may be operable to perform reads and writes, and address objects in its namespace. In one example, a virtual machine may use the RO namespace to access a database such as “Cluster A SQL.” The virtual machine does not need to know the specific identifiers of the storage hardware, but using the RO namespace may be able to directly address areas of the storage hardware. In one embodiment, the virtual machine may address storage areas by using the RO namespace with the IP address and a disk ID.

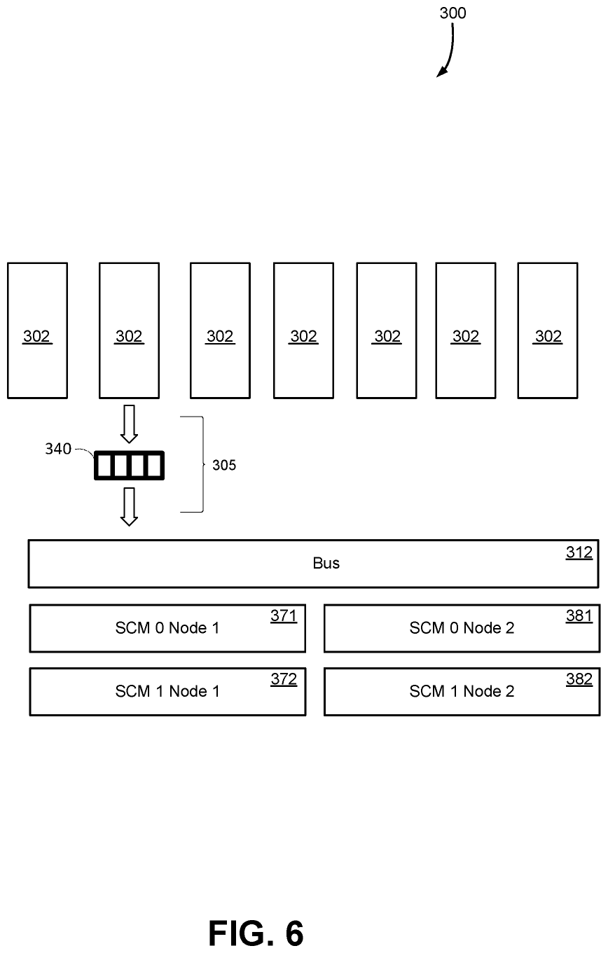

Referring to FIG. 6, the resilient object layer 304 may implement an RO namespace that may be configured to receive names of an entity in the namespace that the virtual machine can call, and translate the called name to a physical namespace. In one example, an entity may be addressed as an IP address and a disk ID. For example, storage devices may be called as SCM 0 at node 1 (371), SCM 1 at node 1 (372), SCM 0 at node 2 (381), and SCM 1 at node 2 (382).

In an embodiment, the RO functionality may reside in the OS. The RO namespace data may be communicated via the virtual machine bus. The hypervisor may be configured to manage the RO path, while from the individual virtual machine perspective, no changes are specifically required. By maintaining a mapping between the virtual machine's call to storage and the underlying storage device, applications need not make any changes to realize the benefits of fast storage access. Thus the operation of virtualized computing services may be improved, providing faster access to storage on par with improvements to storage technology, while maintaining the benefits of virtualized storage in an HCl environment while also providing resiliency. Other applications besides virtual machines may also benefit in a similar manner.

In one embodiment, the virtual machine bus may provide plugins for providing an RO path. For example, if the host receives a read/write request, the host may find the RO path to send the request to, and open a handle to this path. In one example implementation, a after instantiation or loading of a virtual machine and applications running on the virtual machine, when one of the applications requests a write operation, the application may be exposed to a disk which may be redirected via a resilient object path. A backend may be instantiated that interfaces to the disk and provides a namespace, allowing the disk to appear as a traditional disk but without the typical layers. The resilient object layer such as layer 305 of FIGS. 5 and 6 may provide functionality previously provided by legacy stack layers, providing services that allow direct communication with bus 312 and/or storage devices to accomplish necessary tasks, bypassing the layers of software stacks on the data path as performed on legacy systems.

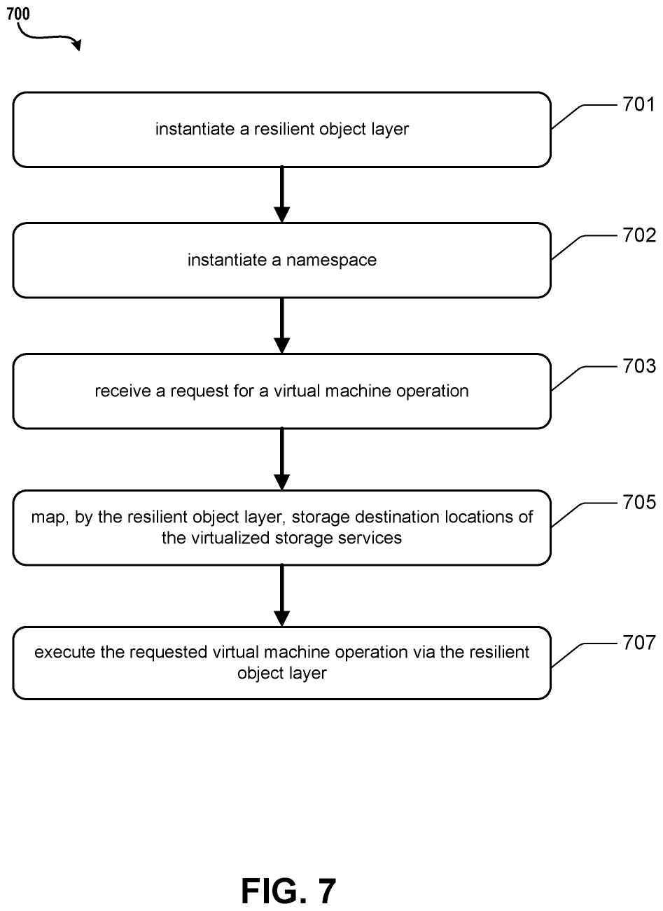

Turning now to FIG. 7, illustrated is an example operational procedure for implementing virtual machines of a virtualized computing environment providing at least virtualized storage services in accordance with the present disclosure. In an embodiment, the example operational procedure can be provided in conjunction with a resilient object layer as illustrated in FIGS. 5 and 6. The operational procedure may be implemented in a system comprising one or more computing devices comprising a plurality of VM containers configured to host virtual machine instances. Referring to FIG. 7, operation 701 illustrates instantiating a resilient object layer that is operable to provide a communication path to storage devices underlying the virtualized storage services.

Operation 701 may be followed by operation 702. Operation 702 illustrates instantiating a namespace configured to address the underlying storage devices. In an embodiment, the resilient object layer and the namespace comprise a compression of two or more layers of a storage stack, each layer providing a service of the storage stack.

Operation 702 may be followed by operation 703. Operation 703 illustrates receiving a request for a virtual machine operation that includes access to the virtualized storage services.

Operation 703 may be followed by operation 705. Operation 705 illustrates in response to the request, mapping, by the resilient object layer, storage destination locations of the virtualized storage services associated with multiple requests to physical locations of the corresponding underlying storage devices. The multiple requests to physical locations may, for example, implement a resilient storage scheme such as a mirroring scheme or a parity scheme.

Operation 705 may be followed by operation 707. Operation 707 illustrates executing the requested virtual machine operation via the resilient object layer.

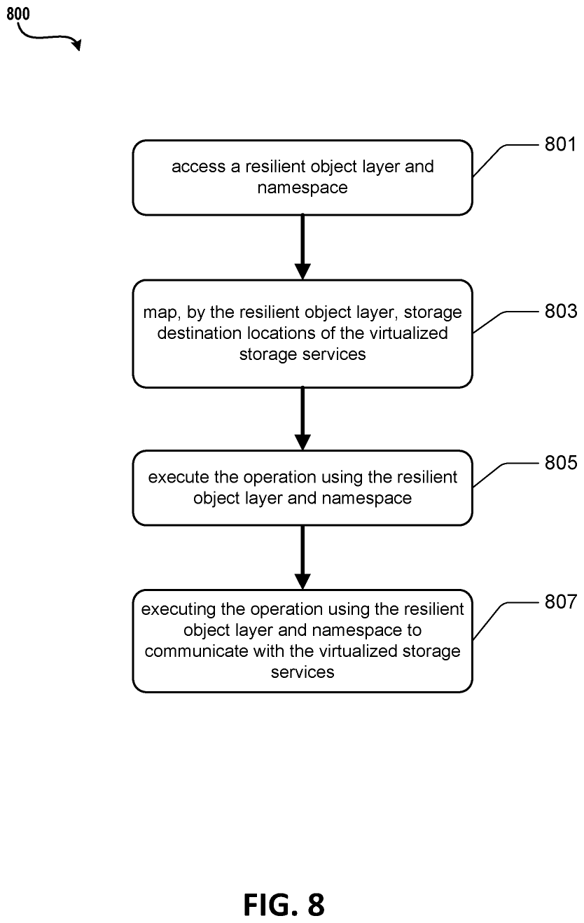

Referring to FIG. 8, illustrated is another example operational procedure for implementing the disclosed embodiments in a computing environment providing at least virtualized storage services in accordance with the present disclosure. In an embodiment, the example operational procedure can be provided in conjunction with a resilient object layer as illustrated in FIGS. 5 and 6. The operational procedure may be implemented, for example, in a system comprising one or more computing devices comprising a plurality of VM containers configured to host virtual machine instances. Referring to FIG. 8, operation 801 illustrates in response to a request for an operation that requires access to virtualized storage services, accessing a resilient object layer that is operable to provide a communication path to storage devices underlying the virtualized storage services and a namespace configured to address the underlying storage devices. In an embodiment, the resilient object layer and the namespace comprise a compression of at least two or more layers of a storage stack.

Operation 801 may be followed by operation 803. Operation 803 illustrates mapping, by the resilient object layer and namespace, storage destination locations of the virtualized storage services associated with a plurality of requests to physical locations of the corresponding underlying storage devices.

Operation 803 may be followed by operation 805. Operation 805 illustrates executing the operation using the resilient object layer and namespace to communicate with the virtualized storage services.

Operation 805 may be followed by operation 807. Operation 807 illustrates executing the virtual machine operation using the resilient object layer to communicate with the virtualized storage services.

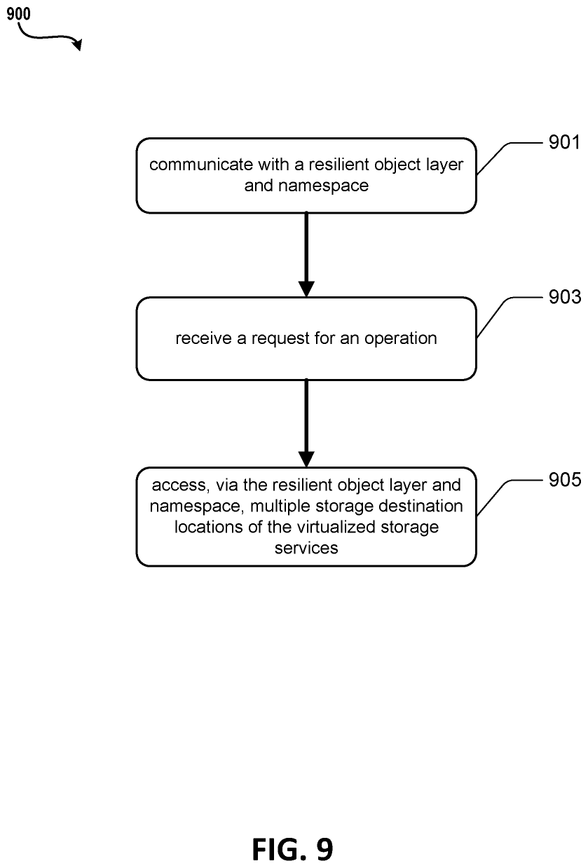

Referring to FIG. 9, illustrated is an example operational procedure for implementing the disclosed techniques in a computing environment providing at least virtualized storage services in accordance with the present disclosure. In an embodiment, the example operational procedure can be provided in conjunction with a resilient object layer as illustrated in FIGS. 5A, 5B, and 6. The operational procedure may be implemented by a computer-readable storage medium having computer-executable instructions stored thereupon which, when executed by one or more processors of a computing device, cause the computing device to perform operations for. Referring to FIG. 9, Operation 901 illustrates communicating with a resilient object layer that is operable to provide a communication path to storage devices underlying the virtualized storage services and a namespace configured to address the underlying storage devices.

Operation 901 may be followed by Operation 903. Operation 903 illustrates receiving a request for an operation that includes access to the virtualized storage services.

Operation 903 may be followed by Operation 905. Operation 905 illustrates in response to the request, accessing, via the resilient object layer and namespace, multiple storage destination locations of the virtualized storage services to physical locations of the corresponding underlying storage devices.

### Example Clauses

The disclosure presented herein may be considered in view of the following clauses.

Example Clause A, a computer-implemented method for implementing virtual machines of a virtualized computing environment providing at least virtualized storage services, the virtual machines executing on one or more computing devices, the method comprising:

instantiating a resilient object layer that is operable to provide a communication path to storage devices underlying the virtualized storage services;

instantiating a namespace configured to address the underlying storage devices;

wherein the resilient object layer and the namespace comprise a compression of two or more layers of a storage stack, each layer providing a service of the storage stack;

receiving a request for a virtual machine operation that includes access to the virtualized storage services; and

in response to the request, mapping, by the resilient object layer, storage destination locations of the virtualized storage services associated with multiple requests to physical locations of the corresponding underlying storage devices.

Example Clause B, the computer-implemented method of Example Clause A, wherein the resilient object layer implements lower services of the storage stack and the namespace implements higher services of the storage stack.

Example Clause C, the computer-implemented method of any one of Example Clauses A through B, wherein the namespace comprises a flat hierarchy and configured to uniquely identify the underlying storage devices.

Example Clause D, the computer-implemented method of any one of Example Clauses A through C, wherein access to the virtualized storage services comprises identifying a storage location with a namespace name, IP address, and disk identifier.

Example Clause E, the computer-implemented method of any one of Example Clauses A through D, further comprising executing the requested virtual machine operation via the resilient object layer and the namespace.

Example Clause F, the computer-implemented method of any one of Example Clauses A through E, wherein the resilient object layer further comprises a compression of at least a network stack.

Example Clause G, the computer-implemented method of any one of Example Clauses A through F, wherein the resilient object layer further comprises a compression of at least an I/O stack.

Example Clause H, the computer-implemented method of any one of Example Clauses A through G, wherein the virtualized storage services implement a mirrored or parity resiliency mechanism.

Example Clause I, the computer-implemented method of any one of Example Clauses A through H, wherein functionality of the storage and file system layers that are not included in the resilient object layer are offloaded.

Example Clause J, the computer-implemented method of any one of Example Clauses A through I, wherein the namespace is configured to uniquely address individual slabs of a storage volume.

Example Clause K, the computer-implemented method of any one of Example Clauses A through J, wherein the resilient object layer is implemented at least in part as a plugin to a virtual machine bus.

Example Clause L, a system, comprising:

one or more processors; and

a memory in communication with the one or more processors, the memory having computer-readable instructions stored thereupon that, when executed by the one or more processors, cause the system to perform operations comprising:

in response to a request for an operation that requires access to virtualized storage services, accessing a resilient object layer that is operable to provide a communication path to storage devices underlying the virtualized storage services and a namespace configured to address the underlying storage devices,

wherein the resilient object layer and the namespace comprise a compression of at least two or more layers of a storage stack;

mapping, by the resilient object layer and namespace, storage destination locations of the virtualized storage services associated with a plurality of requests to physical locations of the corresponding underlying storage devices; and

executing the operation using the resilient object layer and namespace to communicate with the virtualized storage services.

Example Clause M, the system of any one of Example Clause L, wherein the resilient object layer implements lower services of the storage stack and the namespace implements higher services of the storage.

Example Clause N, the system of any one of Example Clauses L through M, wherein access to the virtualized storage services comprises identifying a storage location with a namespace name, IP address, and disk identifier.

Example Clause O, the system of any one of Example Clauses L through N, wherein functionality of the two or more layers that are not included in the resilient object layer and namespace are offloaded.

Example Clause P, the system of any one of Example Clauses L through O, wherein the resilient object layer further comprises a compression of at least an I/O stack.

Example Clause Q, the system of any one of Example Clauses L through P, wherein the resilient object layer further comprises a compression of at least a network stack.

Example Clause R, a computer-readable storage medium having computer-executable instructions stored thereupon which, when executed by one or more processors of a computing device, cause the computing device to:

communicate with a resilient object layer that is operable to provide a communication path to storage devices underlying the virtualized storage services and a namespafce configured to address the underlying storage devices;

receive a request for an operation that includes access to the virtualized storage services; and

in response to the request, access, via the resilient object layer and namespace, multiple storage destination locations of the virtualized storage services to physical locations of the corresponding underlying storage devices.

Example Clause S, the computer-readable storage medium of Example Clause R, wherein the resilient object layer and namespace comprise a compression of at least two layers of a storage stack.

Example Clause T, the computer-readable storage medium of any one of Example Clauses R through S, wherein the resilient object layer implements lower services of the storage stack and the namespace implements higher services of the storage stack.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, or a computing system or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures and other types of structures that perform particular tasks or implement particular abstract data types.

Those skilled in the art will also appreciate that the subject matter described herein may be practiced on or in conjunction with other computer system configurations beyond those described herein, including multiprocessor systems. The embodiments described herein may also be practiced in distributed computing environments, where tasks are performed by remote processing devices that are linked through a communications network. In a distributed computing environment, program modules may be located in both local and remote memory storage devices.

Networks established by or on behalf of a user to provide one or more services (such as various types of cloud-based computing or storage) accessible via the Internet and/or other networks to a distributed set of clients may be referred to as a service provider. Such a network may include one or more data centers such as data center 100 illustrated in FIG. 1, which are configured to host physical and/or virtualized computer servers, storage devices, networking equipment and the like, that may be used to implement and distribute the infrastructure and services offered by the service provider.

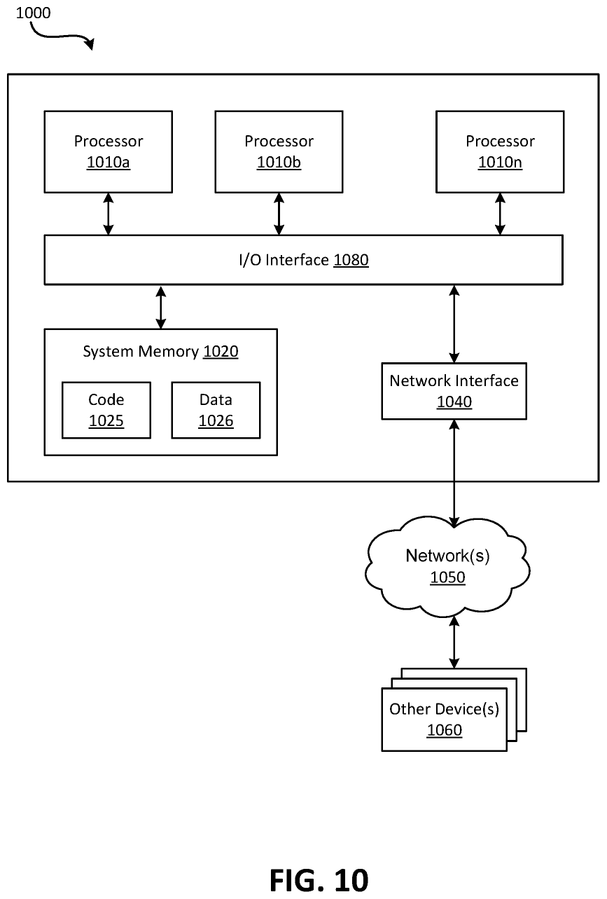

In some embodiments, a server that implements a portion or all of one or more of the technologies described herein, including the techniques to implement the allocation of virtual machines may include a general-purpose computer system that includes or is configured to access one or more computer-accessible media. FIG. 10 illustrates such a general-purpose computing device 1000. In the illustrated embodiment, computing device 1000 includes one or more processors 1010a, 1010b, and/or 1010n (which may be referred herein singularly as “a processor 1010” or in the plural as “the processors 1010”) coupled to a system memory 1020 via an input/output (I/O) interface 1030. Computing device 1000 further includes a network interface 1040 coupled to I/O interface 1030.

In various embodiments, computing device 1000 may be a uniprocessor system including one processor 1010 or a multiprocessor system including several processors 1010 (e.g., two, four, eight, or another suitable number). Processors 1010 may be any suitable processors capable of executing instructions. For example, in various embodiments, processors 1010 may be general-purpose or embedded processors implementing any of a variety of instruction set architectures (ISAs), such as the x106, PowerPC, SPARC, or MIPS ISAs, or any other suitable ISA. In multiprocessor systems, each of processors 1010 may commonly, but not necessarily, implement the same ISA.

System memory 1020 may be configured to store instructions and data accessible by processor(s) 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 1020 as code 1025 and data 1026.

In one embodiment, I/O interface 1030 may be configured to coordinate I/O traffic between the processor 1010, system memory 1020, and any peripheral devices in the device, including network interface 1040 or other peripheral interfaces. In some embodiments, I/O interface 1030 may perform any necessary protocol, timing, or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components. Also, in some embodiments some or all of the functionality of I/O interface 1030, such as an interface to system memory 1020, may be incorporated directly into processor 1010.

Network interface 1040 may be configured to allow data to be exchanged between computing device 1000 and other device or devices 1060 attached to a network or network(s) 1050, such as other computer systems or devices as illustrated in FIGS. 1 through 4, for example. In various embodiments, network interface 1040 may support communication via any suitable wired or wireless general data networks, such as types of Ethernet networks, for example. Additionally, network interface 1040 may support communication via telecommunications/telephony networks such as analog voice networks or digital fiber communications networks, via storage area networks such as Fibre Channel SANs or via any other suitable type of network and/or protocol.

In some embodiments, system memory 1020 may be one embodiment of a computer-accessible medium configured to store program instructions and data as described above for FIGS. 1-7 for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 1000 via I/O interface 1030. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 1000 as system memory 1020 or another type of memory. Further, a computer-accessible medium may include transmission media or signals such as electrical, electromagnetic or digital signals, conveyed via a communication medium such as a network and/or a wireless link, such as may be implemented via network interface 1040. Portions or all of multiple computing devices, such as those illustrated in FIG. 10, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 8, may include other components that are not explicitly shown in FIG. 8, or may utilize an architecture completely different than that shown in FIG. 8.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for implementing virtual machines of a virtualized computing environment providing at least virtualized storage services, the virtual machines executing on one or more computing devices, the method comprising:
instantiating a resilient object layer that is operable to provide a communication path to storage devices underlying the virtualized storage services;
instantiating a namespace configured to address the underlying storage devices;
wherein the resilient object layer and the namespace comprise a compression of two or more layers of a storage stack, each layer providing a service of the storage stack;
receiving a request for a virtual machine operation that includes access to the virtualized storage services; and
in response to the request, mapping, by the resilient object layer, storage destination locations of the virtualized storage services associated with multiple requests to physical locations of corresponding underlying storage devices.

2. The method of claim 1, wherein the resilient object layer implements lower services of the storage stack and the namespace implements higher services of the storage stack.

3. The method of claim 1, wherein the namespace comprises a flat hierarchy and configured to uniquely identify the underlying storage devices.

4. The method of claim 1, wherein access to the virtualized storage services comprises identifying a storage location with a namespace name, IP address, and disk identifier.

5. The method of claim 1, further comprising executing the requested virtual machine operation via the resilient object layer and the namespace.

6. The method of claim 1, wherein the resilient object layer further comprises a compression of at least a network stack.

7. The method of claim 1, wherein the resilient object layer further comprises a compression of at least an I/O stack.

8. The method of claim 1, wherein the virtualized storage services implement a mirrored or parity resiliency mechanism.

9. The method of claim 1, wherein functionality of the storage and file system layers that are not included in the resilient object layer are offloaded.

10. The method of claim 2, wherein the namespace is configured to uniquely address individual slabs of a storage volume.

11. The method of claim 1, wherein the resilient object layer is implemented at least in part as a plugin to a virtual machine bus.

12. A system, comprising:
one or more processors; and
a memory in communication with the one or more processors, the memory having computer-readable instructions stored thereupon that, when executed by the one or more processors, cause the system to perform operations comprising:
in response to a request for an operation that requires access to virtualized storage services, accessing a resilient object layer that is operable to provide a communication path to storage devices underlying the virtualized storage services and a namespace configured to address the underlying storage devices,
wherein the resilient object layer and the namespace comprise a compression of at least two or more layers of a storage stack;
mapping, by the resilient object layer and namespace, storage destination locations of the virtualized storage services associated with a plurality of requests to physical locations of corresponding underlying storage devices; and
executing the operation using the resilient object layer and namespace to communicate with the virtualized storage services.

13. The system of claim 12, wherein the resilient object layer implements lower services of the storage stack and the namespace implements higher services of the storage stack.

14. The system of claim 12, wherein access to the virtualized storage services comprises identifying a storage location with a namespace name, IP address, and disk identifier.

15. The system of claim 12, wherein functionality of the two or more layers that are not included in the resilient object layer and namespace are offloaded.

16. The system of claim 12, wherein the resilient object layer further comprises a compression of at least an I/O stack.

17. The system of claim 12, wherein the resilient object layer further comprises a compression of at least a network stack.

18. A computer-readable storage medium having computer-executable instructions stored thereupon which, when executed by one or more processors of a computing device, cause the computing device to:
communicate with a resilient object layer that is operable to provide a communication path to virtualized storage services and a namespace configured to address storage devices underlying the virtualized storage services;
receive a request for an operation that includes access to the virtualized storage services; and
in response to the request, access, via the resilient object layer and namespace, multiple storage destination locations of the virtualized storage services to physical locations of corresponding underlying storage devices.

19. The computer-readable storage medium of claim 18, wherein the resilient object layer and namespace comprise a compression of at least two layers of a storage stack.

20. The computer-readable storage medium of claim 18, wherein the resilient object layer implements lower services of the storage stack and the namespace implements higher services of the storage stack.
